(19) United States
(12) Patent Application Publication
(10) Pub. No.: US 2026/0342578 A1
(43) Pub. Date: Oct. 29, 2026

(54) ZERO-KNOWLEDGE PROOF OF REGULATORY COMPLIANCE FOR ARTIFICIAL INTELLIGENCE WITH MULTI-JURISDICTIONAL TRUST-STATE ORCHESTRATION AND AUTOMATED ENFORCEMENT

(71) Applicant: George William Bickerstaff, III, Greenwich, CT (US)

(72) Inventor: George William Bickerstaff, III, Greenwich, CT (US)

(21) Appl. No.: 19/737,427

(22) Filed: Jul. 10, 2026

Related U.S. Application Data
(63) Continuation of application No. 19/452,970, filed on Jan. 20, 2026.

(51) Int. Cl. H04L 9/32

(52) U.S. Cl. CPC H04L 9/3218

(57) ABSTRACT

A system and method for zero-knowledge proof of regulatory compliance for artificial intelligence model deployment encodes regulatory requirements into compliance predicates mapped to jurisdiction-specific regulatory regimes, generates and verifies zero-knowledge proofs without disclosure of protected information, and evaluates a single model across multiple jurisdictions simultaneously while avoiding duplicate disclosure. A trust-state orchestration engine receives verified proofs and quantified trust attributes, dynamically updates a trust state based on verification, revocation, or expiration, and automatically gates execution, access, and interoperability across jurisdictions and vendors. Continuous monitoring for model drift or deployment context change automatically triggers re-verification. Cryptographically signed governance receipts provide durable evidence supporting audits and dispute resolution, and immutable logs preserve evidentiary integrity of verification and enforcement events.

### CROSS-REFERENCE TO RELATED APPLICATIONS

This application is a continuation of U.S. patent application Ser. No. 19/452,970, filed Jan. 20, 2026, entitled “ZERO-KNOWLEDGE PROOF OF REGULATORY COMPLIANCE FOR ARTIFICIAL INTELLIGENCE WITH TRUST-STATE ORCHESTRATION,” the entire contents of which are incorporated herein by reference. This application claims the benefit of, and priority to, the filing date of application Ser. No. 19/452,970 under 35 U.S.C. § 120. The specific reference required by 37 CFR 1.78 is set forth in the Application Data Sheet filed herewith.

### TECHNICAL FIELD

The present invention relates to computer-implemented systems for regulatory compliance, governance, and verification of artificial intelligence systems.

More particularly, the invention relates to systems and methods for generating and verifying zero-knowledge proofs demonstrating regulatory compliance of artificial intelligence models without disclosure of protected information, and for enforcing execution, access, and interoperability through trust-state orchestration.

### BACKGROUND

Artificial intelligence systems are increasingly deployed in regulated environments including healthcare, finance, insurance, critical infrastructure, and cross-border data ecosystems.

Regulatory frameworks governing such deployments require demonstrable compliance with safety, privacy, fairness, accountability, and operational constraints.

Conventional compliance verification mechanisms require disclosure of training data, model parameters, validation results, or proprietary logic, creating unacceptable risks to intellectual property, privacy, and competitive advantage.

Existing audit-based or privacy-preserving approaches do not provide a system-level mechanism for cryptographically proving compliance while simultaneously enforcing execution decisions in operational environments.

Accordingly, there exists a need for a technical system that enables regulatory compliance to be proven without disclosure and enforced through automated, cryptographically verifiable governance mechanisms.

### SUMMARY OF THE INVENTION

The invention provides a computer-implemented system that encodes regulatory requirements into compliance predicates, generates zero-knowledge proofs demonstrating satisfaction of those predicates, verifies the proofs, and enforces execution using a trust-state orchestration system.

Verified compliance proofs are combined with quantified trust attributes to dynamically govern deployment, execution, access, and interoperability of artificial intelligence models across jurisdictions and vendors.

### BRIEF DESCRIPTION OF THE DRAWINGS

FIG. 1 illustrates an overall system architecture for zero-knowledge regulatory compliance and governance of artificial intelligence models.

FIG. 2 illustrates creation, encoding, versioning, and distribution of compliance manifests representing regulatory requirements.

FIG. 3 illustrates generation and aggregation of zero-knowledge proofs demonstrating regulatory compliance without disclosure of protected information.

FIG. 4 illustrates verification of compliance proofs and enforcement of governance decisions based on verification results.

FIG. 5 illustrates trust-state orchestration governing execution, interoperability, and continuous compliance of artificial intelligence models.

### DETAILED DESCRIPTION OF THE DRAWINGS

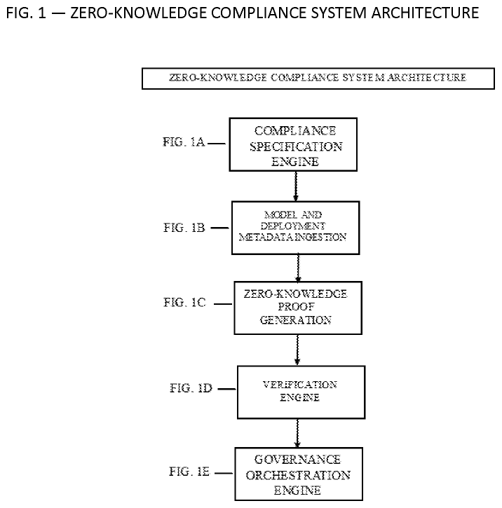

### FIG. 1—Zero-Knowledge Compliance System Architecture

FIG. 1 illustrates an overall system architecture for zero-knowledge regulatory compliance verification. The architecture depicts coordinated engines for compliance specification, proof generation, verification, and governance enforcement. Protected model data is cryptographically isolated throughout the system.

### FIG. 1A—Compliance Specification Engine

FIG. 1A illustrates a compliance specification engine configured to encode regulatory frameworks into machine-readable compliance predicates. Regulatory requirements are normalized and versioned to support auditability and jurisdiction-specific enforcement. The engine produces compliance manifests consumed by downstream components.

### FIG. 1B—Model and Deployment Metadata Ingestion

FIG. 1B illustrates ingestion of model metadata and deployment context information. Sensitive attributes are represented using cryptographic commitments rather than raw disclosure. The metadata enables evaluation of compliance predicates without revealing protected information.

### FIG. 1C—Zero-Knowledge Proof Generation Engine

FIG. 1C illustrates a proof generation engine that constructs zero-knowledge proofs demonstrating satisfaction of compliance predicates. Proof generation occurs without exposing training data, model parameters, or proprietary logic. The engine supports regeneration as requirements or deployment contexts change.

### FIG. 1D—Verification Engine

FIG. 1D illustrates a verification engine configured to validate zero-knowledge proofs against compliance manifests and public verification keys. Verification produces deterministic and repeatable results suitable for regulatory review. No protected information is disclosed during verification.

### FIG. 1E—Governance Orchestration Engine

FIG. 1E illustrates a governance orchestration engine that enforces deployment and execution decisions based on verified proofs. The engine permits, restricts, or denies operation of artificial intelligence models. Cryptographically signed governance receipts are generated for audit and evidentiary purposes.

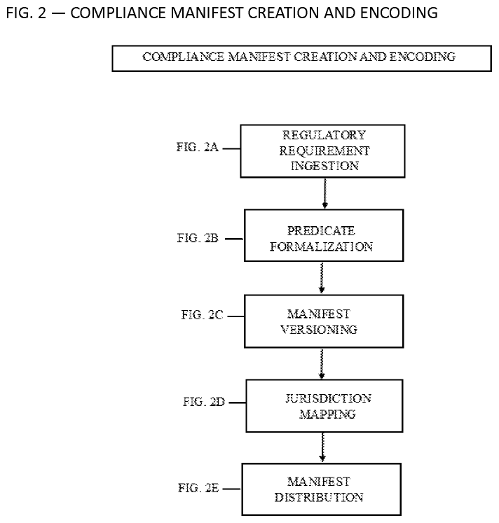

### FIG. 2—Compliance Manifest Creation and Encoding

FIG. 2 illustrates creation and management of compliance manifests. Regulatory requirements are transformed into structured artifacts usable by cryptographic proof systems. Manifests enable scalable and repeatable compliance verification.

### FIG. 2A—Regulatory Requirement Ingestion

FIG. 2A illustrates ingestion of regulatory texts, standards, and policy rules from authoritative sources. Requirements are parsed and normalized into formal representations. Updates are tracked to preserve historical traceability.

### FIG. 2B—Predicate Formalization

FIG. 2B illustrates transformation of regulatory requirements into mathematically verifiable compliance predicates. Predicates express conditions relating to safety, privacy, fairness, and performance. Predicate logic supports reuse across multiple regulatory frameworks.

### FIG. 2C—Manifest Versioning

FIG. 2C illustrates versioning of compliance manifests over time. Versioning supports regulatory evolution and retrospective audits. Past compliance states remain verifiable.

### FIG. 2D—Jurisdiction Mapping

FIG. 2D illustrates mapping of compliance predicates to jurisdiction-specific regulatory regimes. A single artificial intelligence model may be evaluated across multiple jurisdictions simultaneously. Duplicate disclosure is avoided.

### FIG. 2E—Manifest Distribution

FIG. 2E illustrates secure distribution of signed compliance manifests. Manifests are cryptographically protected against tampering. Trust in downstream verification outcomes is preserved.

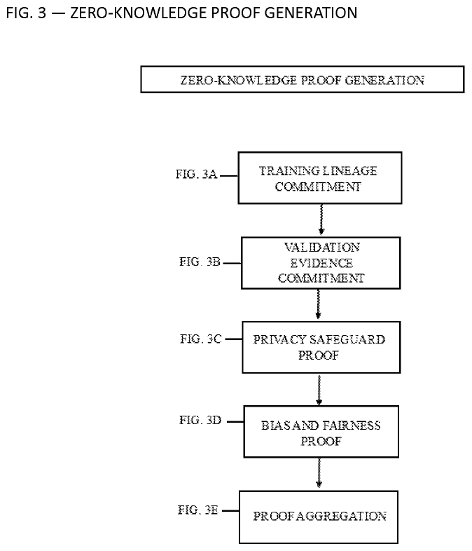

### FIG. 3—Zero-Knowledge Proof Generation

FIG. 3 illustrates generation of zero-knowledge proofs demonstrating regulatory compliance. Proofs are generated without revealing protected information. Aggregation enables efficient verification.

### FIG. 3A—Training Lineage Commitment

FIG. 3A illustrates cryptographic commitment to training data provenance. Commitments demonstrate compliance with data sourcing requirements. Raw training data remains confidential.

### FIG. 3B—Validation Evidence Commitment

FIG. 3B illustrates commitment to validation outcomes such as accuracy and robustness. Proofs demonstrate threshold satisfaction without exposing validation datasets. Regulatory assurance is preserved.

### FIG. 3C—Privacy Safeguard Proof

FIG. 3C illustrates proof of implemented privacy safeguards. Compliance with data protection requirements is demonstrated cryptographically. Sensitive personal data is not disclosed.

### FIG. 3D—Bias and Fairness Proof

FIG. 3D illustrates proof that bias and fairness constraints are satisfied. Equity thresholds are proven without revealing protected attributes. Continuous fairness governance is supported.

### FIG. 3E—Proof Aggregation

FIG. 3E illustrates aggregation of multiple zero-knowledge proofs into a composite proof. Aggregation reduces verification overhead. End-to-end compliance is efficiently demonstrated.

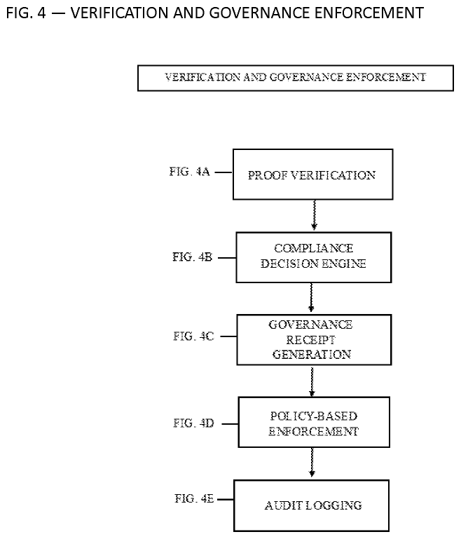

### FIG. 4—Verification and Governance Enforcement

FIG. 4 illustrates verification of compliance proofs and enforcement of governance decisions. Verified results directly control execution. All actions are auditable.

### FIG. 4A—Proof Verification

FIG. 4A illustrates cryptographic verification of zero-knowledge proofs. Verification confirms satisfaction of compliance predicates. Results are deterministic.

### FIG. 4B—Compliance Decision Engine

FIG. 4B illustrates evaluation of verification results to produce compliance decisions. Decisions may approve, conditionally approve, or deny execution. Policies are applied consistently.

### FIG. 4C—Governance Receipt Generation

FIG. 4C illustrates generation of cryptographically signed governance receipts. Receipts provide durable evidence of compliance. Receipts support audits and dispute resolution.

### FIG. 4D—Deployment Context Enforcement

FIG. 4D illustrates enforcement of execution constraints based on verified deployment context. Jurisdictional and operational limitations are enforced automatically. Unauthorized execution is prevented.

### FIG. 4E—Audit Logging

FIG. 4E illustrates immutable logging of verification and enforcement events. Logs preserve evidentiary integrity. Regulatory review is simplified.

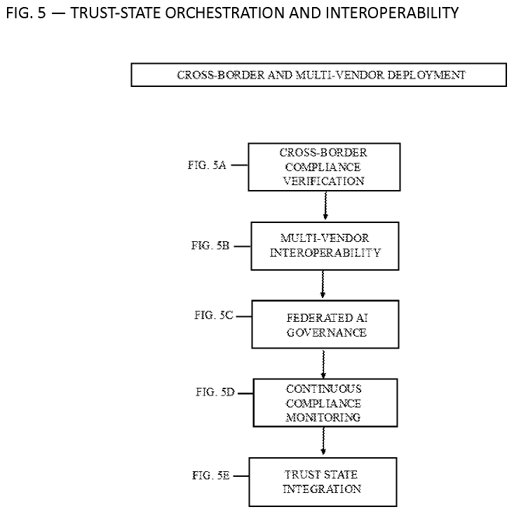

### FIG. 5—Trust-State Orchestration and Interoperability

FIG. 5 illustrates trust-state orchestration governing execution of artificial intelligence models. Trust states integrate compliance proofs and trust attributes. Execution is conditionally enabled.

### FIG. 5A—Trust Attribute Ingestion

FIG. 5A illustrates ingestion of quantified trust attributes. Trust attributes may represent authority, credibility, or verification status. Attributes are machine-readable.

### FIG. 5B—Trust State Update

FIG. 5B illustrates dynamic updating of trust states. Trust states evolve based on verification, revocation, or expiration. Historical trust transitions are preserved.

### FIG. 5C—Execution Gating

FIG. 5C illustrates gating of execution based on trust state. Models execute only when trust conditions are satisfied. Enforcement is automatic.

### FIG. 5D—Continuous Compliance Monitoring

FIG. 5D illustrates continuous monitoring for model drift or context change. Re-verification is triggered automatically. Compliance remains current.

### FIG. 5E—Cross-System Interoperability

FIG. 5E illustrates interoperability across platforms and vendors using trust states. Execution eligibility is communicated securely. Proprietary information remains protected.

What is claimed is:

1. A computer-implemented system for regulatory compliance of artificial intelligence model deployment across multiple jurisdictions, the system comprising one or more processors and memory storing instructions that, when executed by the one or more processors, implement: a compliance specification engine configured to encode regulatory requirements into machine-readable compliance predicates, wherein compliance predicates are mapped to jurisdiction-specific regulatory regimes; a proof generation engine configured to generate zero-knowledge proofs demonstrating satisfaction of the compliance predicates without revealing protected information; a verification engine configured to verify the zero-knowledge proofs against compliance manifests and public verification keys; a trust-state orchestration engine configured to receive verified zero-knowledge compliance proofs and quantified trust attributes, dynamically update a trust state based on verification, revocation, or expiration, and gate execution, access, or interoperability of an artificial intelligence model across jurisdictions and vendors based on the trust state; and a governance receipt generator configured to generate cryptographically signed governance receipts for audit and evidentiary purposes.

2. A computer-implemented method for regulatory compliance of artificial intelligence model deployment, the method comprising: encoding regulatory requirements into machine-readable compliance predicates mapped to jurisdiction-specific regulatory regimes; generating zero-knowledge proofs demonstrating satisfaction of the compliance predicates without revealing protected information; verifying the zero-knowledge proofs; updating a trust state based on the verified zero-knowledge proofs and quantified trust attributes; gating execution of an artificial intelligence model across jurisdictions based on the trust state; generating cryptographically signed governance receipts; and maintaining immutable logs of verification and enforcement events.

3. A computer-implemented system comprising one or more processors and memory storing instructions that, when executed by the one or more processors, implement a trust-state orchestration engine configured to: receive verified zero-knowledge compliance proofs and quantified trust attributes associated with an artificial intelligence model; dynamically update a trust state of the artificial intelligence model based on verification, revocation, or expiration; gate execution, access, or interoperability of the artificial intelligence model based on the trust state, wherein enforcement is automatic; automatically trigger re-verification upon continuous monitoring detecting model drift or deployment context change; and generate cryptographically signed governance receipts for audit and evidentiary purposes.

4. The system of claim 1, wherein a single artificial intelligence model is evaluated against compliance predicates of multiple jurisdictions simultaneously, and duplicate disclosure of protected information is avoided.

5. The system of claim 1, wherein multiple zero-knowledge proofs are aggregated into a composite proof demonstrating satisfaction of multiple compliance predicates.

6. The method of claim 2, further comprising continuously monitoring for model drift or deployment context change and automatically triggering re-verification of the zero-knowledge proofs.

7. The system of claim 3, wherein historical trust-state transitions are preserved for audit and regulatory review.

8. The method of claim 2, wherein aggregated zero-knowledge proofs demonstrate satisfaction of compliance predicates of multiple jurisdictions simultaneously without duplicate disclosure of protected information.

9. The system of claim 1, wherein execution constraints, including jurisdictional and operational limitations, are enforced automatically based on verified deployment context, and unauthorized execution is prevented.

10. The system of claim 3, wherein execution of the artificial intelligence model is permitted only while the trust state remains valid, and is automatically restricted upon revocation or expiration of the trust state.

11. The method of claim 2, wherein compliance is evaluated across at least three jurisdictions simultaneously.

12. The system of claim 1, wherein the compliance predicates comprise at least one of a training data provenance requirement, a validation performance threshold, a privacy safeguard requirement, or a bias or fairness constraint.

13. The system of claim 3, wherein, upon detected model drift, the trust-state orchestration engine automatically triggers regeneration and re-verification of the zero-knowledge proofs and a corresponding update of the trust state.

14. The method of claim 2, wherein the cryptographically signed governance receipts provide durable evidence of compliance and support audits and dispute resolution.

15. The system of claim 1, wherein a cryptographically signed governance receipt is generated upon a compliance decision to deny or restrict execution of the artificial intelligence model.

16. The system of claim 3, wherein the trust state evolves based on revocation or expiration, and execution gating is adjusted automatically without manual intervention.

17. The method of claim 2, wherein gating execution across jurisdictions is performed without separate disclosure of protected information for each jurisdiction.

18. The system of claim 1, wherein the proof generation engine is configured to regenerate zero-knowledge proofs as regulatory requirements or deployment contexts change.

19. The system of claim 3, wherein execution eligibility of the artificial intelligence model is communicated securely across platforms and vendors using the trust state while proprietary information remains protected.

20. The method of claim 2, wherein the immutable logs preserve evidentiary integrity of verification and enforcement events for regulatory review.
